(19) United States
(12) Patent Application Publication
(10) Pub. No.: US 2015/0362931 A1
(43) Pub. Date: Dec. 17, 2015

(54) HIGH-EFFICIENCY PUMP AND DUMP CIRCUIT HAVING REDUCED STORAGE CAPACITOR

(71) Applicant: TEXAS INSTRUMENTS INCORPORATED, Dallas, TX (US)

(72) Inventors: Hassan Pooya Forghani-Zadeh, Fort Worth, TX (US); Abdelhalim M. Alsharqawi, Richardson, TX (US); Suhwan Kim, Addison, TX (US)

(21) Appl. No.: 14/587,796

(22) Filed: Dec. 31, 2014

Related U.S. Application Data
(60) Provisional application No. 62/013,356, filed on Jun. 17, 2014.

(51) Int. Cl. G05F 1/10

(52) U.S. Cl. CPC G05F 1/10

(57) ABSTRACT

A device includes an input voltage supply line, a processing component, an input capacitor, a storage capacitor, a buck/boost converter and a controlling component. The input voltage supply line receives an input voltage, Vᵢₙ. The processing component receives Vᵢₙ and performs a function using Vᵢₙ. The input capacitor stores an input capacitance voltage, V_{cin}, from Vᵢₙ. The storage capacitor stores a storage capacitance voltage, V_{cs}. The buck/boost converter provides V_{cs} to the storage capacitor in a first state such that V_{cs}>V_{cin}, and provides energy to the input capacitor from the storage capacitor in a second state. The controlling component controls the buck/boost converter to operate in the second state when Vᵢₙ is below it predetermined threshold.

The present application claims priority from: U.S. Provisional Application No. 62/013,356 filed Jun. 17, 2014, the entire disclosure of which is incorporated herein by reference.

### BACKGROUND

In some power management systems, power down should be controlled enough so the system can gracefully shut down. An example of such an application is the digital subscriber line or xDSL modem standards compliant applications, which require manufacturers to allow for a “dying gasp” time when input power is disconnected. Typically, this dying gasp is on the order of 60 milliseconds. During this dying gasp, xDSL modems can communicate with the central computer about the shutdown and allow for better traffic handling.

Conventional solutions generally employ large external capacitors to store enough energy to operate the xDSL modem for the dying gasp period. The size of the storage capacitors in these solutions range from 2000 μF to 8000 μF. Because these are large external capacitors, they are bulky and expensive.

FIG. 1 illustrates a conventional single capacitor system 100.

As illustrated in the figure, block diagram 100 includes a capacitor 102 and a modem 104.

Capacitor 102 is arranged to receive power 110, via a line 106. Capacitor 102 is additionally arranged to provide power 112 to modem 104, via a line 108.

Modem 104 is arranged to receive power 112 from capacitor 102, via line 108. Modem 104 detects the voltage of power 110, via line 106. Modem 104 operates in a normal operating mode and operates in a dying gasp mode when the voltage of power 110 drops some predetermined threshold, such as below 90% of its nominal value.

In operation, power 110 is being delivered to capacitor 102, via line 106, and modem 104 is operating in its normal operating mode. Capacitor 102 is storing power 110 and is simultaneously transmitting stored power 110 as power 112, via line 108, to modem 104.

Modem 104 is in normal operating mode, which means that modem 104 communicates with a client (not shown), via signal 116 and line 114. Simultaneously, modem 104 monitors the voltage of power 110, via line 106.

At some later time power 110 is cut off. When power 110 is cut off, the voltage of power 110 begins to drop. Non-limiting examples of why power 110 may be cut of include a power outage, unplugged power cord, or hardware malfunction.

Modem 104 detects a drop below 90% of the nominal voltage of power 110 and begins operating in dying gasp mode. In dying gasp mode, modem 108 transmits session end signal 116 to a client (not shown), via line 114, in order to end a session until power 110 is returned and modem 104 can resume operation. The dying gasp in this example embodiment needs to last 60 milliseconds, and the voltage at which power 110 is being delivered to capacitor 102 is 5 Volts. This means that capacitor 102 needs to store enough energy to power modem 104 for 60 ms.

In other conventional systems, two capacitors may be used. A first capacitor is used to deliver power during a devices normal operation mode, and as second capacitor is used to deliver power during a devices dying gasp mode. A conventional system using two capacitors will now be discussed with reference to FIG. 2.

FIG. 2 illustrates a conventional two capacitor system 200.

As illustrated in the figure, block diagram 200 includes a capacitor 202, a capacitor 204, and a modem 206.

Capacitor 202 is arranged to receive power 216 via as line 208. Capacitor 202 is operable to transmit power 218 to modem 206, via line 210.

Capacitor 204 is additionally arranged to receive power 216, via line 208. Capacitor 204 is additionally operable to transmit power 222 to modem 206, via line 214, when the voltage of power 218 drops below 90% of its nominal value.

Modem 206 is operable to detect the voltage of power 218. Modem 206 has a normal operating mode and a dying gasp mode when the voltage of power 218 drops below 90% of its nominal value. Modem 206 is further operable to transmit session end signal 226, via line 224 when operating in dying gasp mode.

In this example embodiment, two capacitors are used to store energy. Capacitor 202 is used to supply modem 206 with power during its normal operating mode and capacitor 204 is used for storing energy for the dying gas mode of modem 206. Capacitor 204 much larger than capacitor 202 so that capacitor 204 may store enough energy to allow modem 206 to operate in its dying gasp mode.

In operation, power 216 is being delivered to capacitor 202 and to capacitor 204, via line 208. When modem 206 is in its normal operating mode, it draws power 218 from capacitor 202, via line 210. When modem 206 is in normal operating mode, modem 206 communicates with a client (not shown), via signal 226 over line 224. Simultaneously, modem 206 monitors the voltage of power 216, via line 208, in order to detect a drop in voltage.

At some later time power 216 is cut off. When power 216 is cut off, the voltage of power 216 begins to drop. Modem 206 and capacitor 204 detect that the voltage of power 216 below 90% of the nominal voltage of power 216 and modem 206 begins operating in dying gasp mode. In dying gasp mode, modem 206 transmits session end signal 226 to the client (not shown), via line 224, in order to end a session until power 216 is returned and modem 206 can resume operation.

Once the voltage of power 210 drops to 90% of its nominal value, capacitor 204 provides power 222 to modem 206, via line 214. An example operation of a two capacitor system is disclosed in U.S. Pat. No. 7,940,118 B1, the entire disclosure of which is incorporated herein by reference.

Modem 206 will use power 222 to operate in dying gasp mode and transmit session end signal 226 to a client, via line 224, to terminate the session until power 216 is returned.

The problem with the conventional system and method for providing power during a modems dying gasp mode is that it requires very large, bulky, and expensive capacitors. These large capacitors are needed in order to provide power for a long enough time For the modem to terminate a client session while in its dying gasp mode. Another problem with the conventional system and method for providing power during a dying gasp is that extremely complex circuitry is needed to use two capacitors to provide power during a modems dying gasp mode.

What is needed is a system and method for efficiently storing sufficient energy to power a modem in its dying gasp mode that does not require the use of large and expensive capacitors.

### BRIEF SUMMARY

The present disclosure is drawn to system and method for efficiently storing sufficient energy to power a modem in its dying gasp mode that does not require the use of large and expensive capacitors.

An aspect of the present disclosure is drawn to a device includes an input voltage supply line, a processing component, an input capacitor, a storage capacitor, a buck/boost converter and a controlling component. The input voltage supply line receives an input voltage, Vᵢₙ. The processing component receives Vᵢₙ and performs a function using Vᵢₙ. The input capacitor stores an input capacitance voltage, V_{cin}, from Vᵢₙ. The storage capacitor stores a storage capacitance voltage, V_{cs}. The buck/boost converter provides V_{cs} to the storage capacitor in a first state such that V_{cs}>V_{cin}, and provides energy to the input capacitor from the storage capacitor in a second state. The controlling component controls the buck/boost converter to operate in the second state when Vᵢₙ is below a predetermined threshold.

Additional advantages and novel features of the disclosure are set forth in part in the description which follows, and in part will become apparent to those skilled in the art upon examination of the following or may be learned by practice of the disclosure. The advantages of the disclosure may be realized and attained by means of the instrumentalities and combinations particularly pointed out in the appended claims.

### BRIEF SUMMARY OF THE DRAWINGS

The accompanying drawings, which are incorporated in and form a part of the specification, illustrate example embodiments of the present disclosure and, together with the description, serve to explain the principles of the disclosure. In the drawings:

FIG. 1 illustrates a conventional single capacitor system;

FIG. 2 illustrates a conventional two capacitor system;

FIG. 3 illustrates an example two capacitor system in accordance with aspects of the present disclosure;

FIG. 4A illustrates an example bi-directional buck-boost converter, when operating in a boost mode, in accordance with aspects of the present disclosure; and

FIG. 4B illustrates a block diagram of the example bi-directional buck-boost converter, when operating in a buck mode, in accordance with aspects of the present disclosure.

### DETAILED DESCRIPTION

The present disclosure provides a system and method for storing and providing energy to power a device for the duration of its dying gasp mode, with the use of two capacitors and a bi-directional buck-boost converter.

In accordance with a first aspect of the present disclosure, two capacitors with different voltage ratings, and a bi-directional buck boost converter are used to deliver power during a devices dying gasp mode. A first small capacitor and a power supply are used to deliver power to a device when it is in its normal operating mode, and a storage capacitor is used to deliver power when the power supply is cut.

Using a single capacitor requires the capacitor to be very large in order to store enough energy to power a device while it operates in thing gasp mode. Aspects of the present disclosure take advantage of the phenomenon that the energy stored in a capacitor is proportional to its voltage rating as given by the equation:

$$U = \frac{1}{2} C {V}^{2} \qquad ( 1 )$$

where U is the energy stored, C is capacitance, and V is voltage.

In accordance with the present disclosure, a low side current sensor (CSL), a high side current sensor (CSH), two switches connected to an inductor, and a gate driver are used in a bi-directional buck boost converter to store and supply power to a modem. If the bi-directional buck-boost converter is in boost mode, the CSL is turned on the CSH is turned off, and if the bi-directional buck-boost converter is buck mode, the CSL is turned off and the CSH is turned on. In boost mode, the CSL is used to monitor the current of the energy stored by the storage capacitor.

The current sensed by the CSL is used by the gate driver to modify the pulse width modulation (PWM) signal controlling the two switches of the bi-directional buck-boost converter. PWM is used to control the opening and closing of a low side switch and high side switch. When the PWM signal is high, it closes the high side switch and opens the low side switch. Similarly, when the PWM signal is low, it opens the high side switch and closes the low side switch. The rate at which the low side switch and high side switch turn either on or off controls the current that flows through an inductor.

In boost mode, the frequency of the PWM signal can then be modified by the gate driver to either increase or decrease the current flowing through the inductor to the storage capacitor based on the current sensed by the CSL. Increasing the current will decrease the voltage of energy being stored by the storage capacitor, while decreasing the current will increase the voltage of the energy stored by the storage capacitor.

When a loss of power is detected, the bidirectional buck-boost converter switches from boost mode to buck mode. In buck mode, the CSH is turned on and the CSL is turned off. In buck mode, the CSH is used to monitor the current of the energy being discharged from the storage capacitor to the modem. The current sensed by CSH can be used by the gate driver to modify the frequency of the PWM signal to either increase or decrease the voltage of the power flowing to the modem by increasing or decreasing the current of energy discharged from the storage capacitor.

Using a bi-directional buck-boost converter to boost the voltage of energy being stored by a storage capacitor and lower the voltage of energy in the storage capacitor during buck mode is much more efficient than conventional systems while also reducing the overall system cost and physical size.

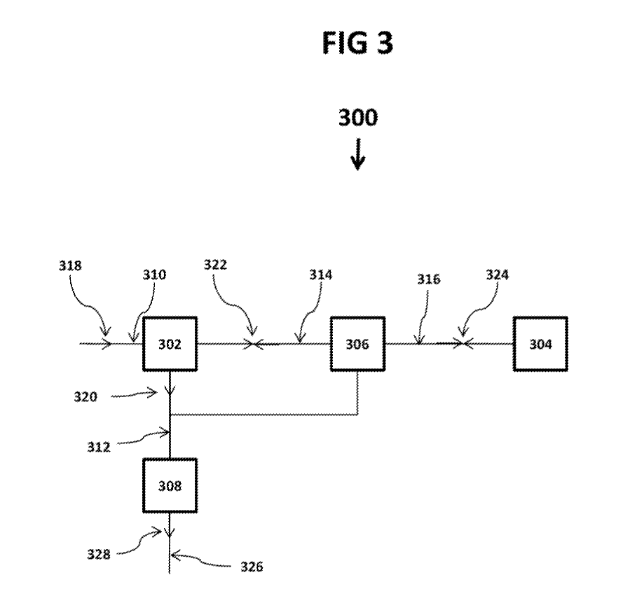

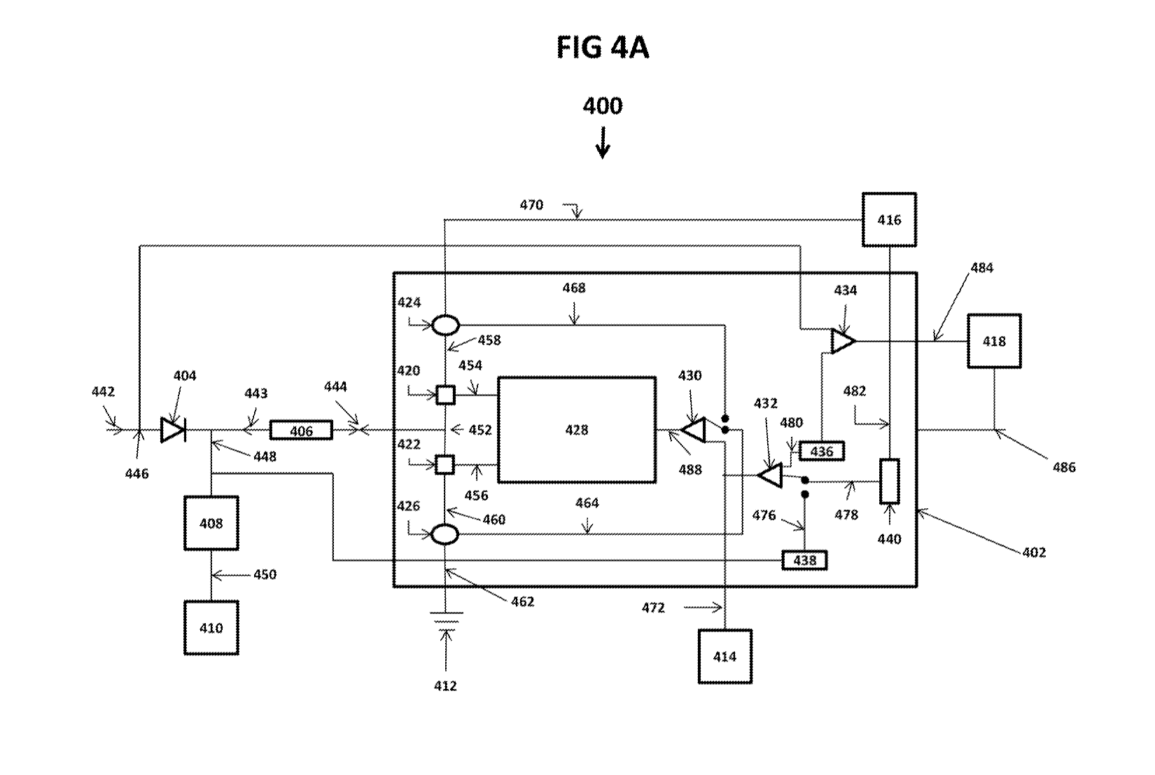

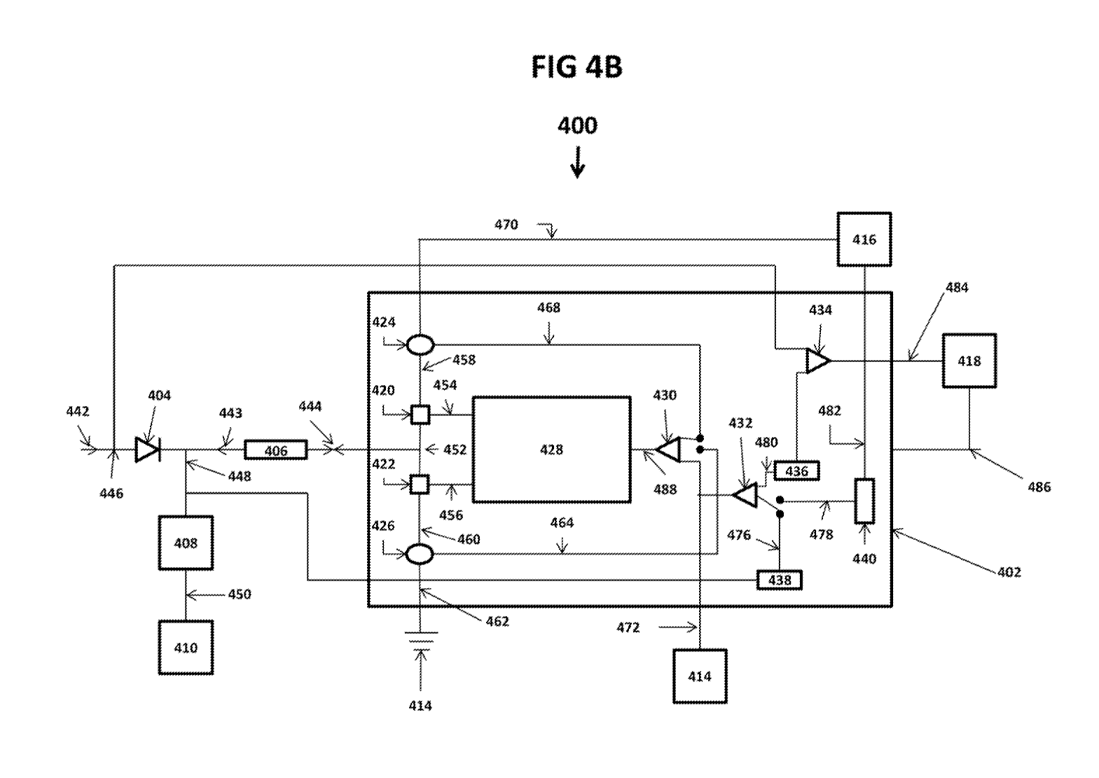

Example systems in accordance with the first aspect of the present disclosure will now be described with reference to FIGS. 3-4B.

FIG. 3 illustrates an example two capacitor system 300 operating in a boost mode in accordance with aspects of the present disclosure.

As illustrated in the figure, system 300 includes a capacitor 302, a capacitor 304, a bi-directional buck-boost converter 306, and a modem 308.

Capacitor 302 is arranged to receive power 318, via line 310. Capacitor 302 is additionally arranged to transmit or receive power 322 from bi-directional buck-boost converter 306, via bi-directional line 314. Capacitor 302 is further arranged to power 320 to modem 308, via line 312, where power 320 is less than power 318.

Capacitor 304 is arranged to transmit or receive power 324 from bi-directional buck-boost converter 306, via bi-directional line 316.

Bi-directional buck-boost converter 306 is arranged to transmit or receive power 322 from capacitor 302, via bi-directional line 314, and transmit or receive power 324 from capacitor 304, via bi-directional line 316. Bi-directional buck-boost converter 306 is operable to detect the voltage of power 320, via line 312. Bi-directional buck-boost converter 306 is further operable to operate in boost mode or buck mode. In the boost mode, bi-directional buck-boost converter 306 charges capacitor 304, whereas in the buck mode, buck-boost converter 306 discharges capacitor 304.

Modem 308 is arranged to receive power 320, via line 312, from capacitor 302. Modem 308 may operate in a normal operating mode and operate in a dying gasp mode when the voltage of power 318 drops below a predetermined threshold, e,g., 90% of its nominal value. In an example embodiment, the nominal voltage of power 318 is 5 Volts. In the dying gasp mode, modem 308 may transmit session end signal 328, via line 326.

In this example embodiment, two capacitors are used to store energy. Capacitor 302 is used to supply modem 308 with power during its normal operating mode and capacitor 304 is used to supply energy during the dying gas mode of modem 308.

Using two capacitors with different voltage ratings allows power to be stored for the dying gasp mode on a much smaller capacitor than that of conventional single capacitor system 100. Capacitor 302 can be used with the input voltage, Vᵢₙ, which in this case is the voltage of power 318 and can store an input capacitance voltage, V_{cin}, based on its capacitance during the normal operating mode of modem 308. Since power 320 is less than power 318, capacitor 302 can deliver the excess of power 318 to bi-directional buck-boost converter 306 as power 322, via bi-directional line 314.

Buck-boost converter 306 will convert power 322 to power at a much higher voltage and lower current. After being converted, buck-boost converter 306 will transmit converted power 322 as power 324 to capacitor 304, via bi-directional line 316. Power 324 is converted to a higher voltage and lower current because the amount of energy stored U, of equation (1) is proportional to voltage V.

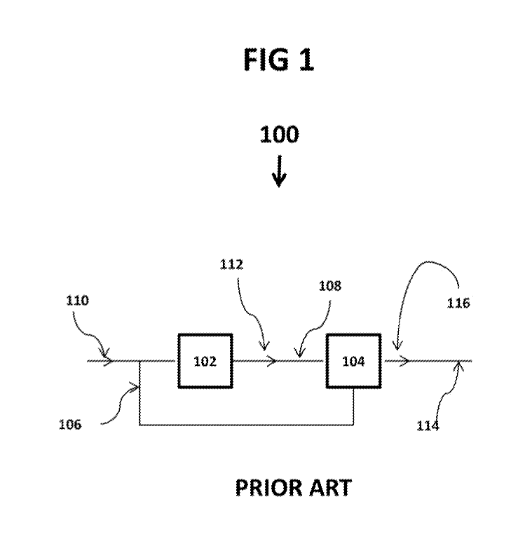

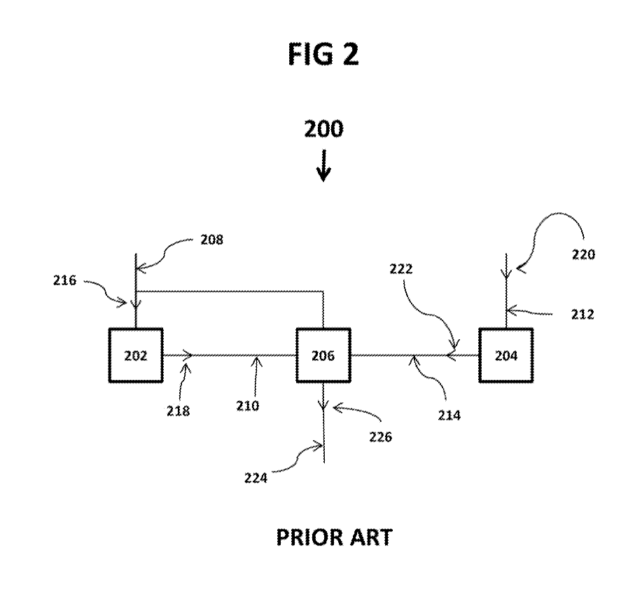

Generally speaking, the total capacitance needed by capacitor 304, to store an equal amount of energy as compared to capacitor 204 of FIG. 2, is at least an order of magnitude less than the total capacitance need by capacitor 204. Power is a related to voltage and time as follows;

$$P = \frac{v}{c} \qquad ( 2 )$$

where P is power, t is time, and U is energy. The voltage stored in capacitor 304 is a storage capacitance voltage, V_{cs}. In this example embodiment, suppose that the amount of power needed by modem 308 to operate in the dying gasp mode for 60 ms is 1 Watt and that bi-directional buck-boost converter 306 converts the voltage of power 322 from 5 V to 20 V. From equation (2), it can be found that the total amount of energy needed to be stored by capacitor 304 is 0.06 Joules. Substituting 0.06 Joules for energy U and 20 Volts for V into equation (1), it can be found that the total capacitance needed by capacitor 304 is 300 μF. For purposes of comparison, capacitor 204 may require a capacitance of 4800 μF as compared to the 300 μF capacitance of capacitor 304 in order to store an equal amount of energy. Clearly, the capacitance required by a system in accordance with aspects of the present disclosure is significantly less than the 4800 μF capacitance required in FIG. 1.

In operation, power 318 is being delivered to capacitor 302, via line 310. Capacitor 302 delivers power 320 to modem 308, via line 312. Capacitor 302 will deliver excess power 318 not be transmitted to modem 308 to bi-directional buck-boost converter 306 as power 322, via bi-directional line 314. At the beginning of the operating of system 300, bi-directional buck-boost converter 306 operates in boost mode.

In boost mode, bi-directional buck-boost converter 306 begins converting power 322 to higher voltage. As described above, in an example embodiment, bi-directional buck-boost converter 306 converts the voltage of power 322 from 5 Volts to 20 Volts. Buck-boost converter 306 transmits converted power 322, as power 324, to capacitor 304, via bi-directional line 316, until it is fully charged.

Simultaneously, modem 308 is in normal operating mode, which means that modem 308 communicates with a client (not shown), via session end signal 328 and line 326. At the same time bi-directional buck-boost converter 306 monitors the voltage of power 320, via line 312, in order to detect a drop in voltage. Capacitor 302, capacitor 304, bi-directional buck-boost converter 306, and modem 308 will continue to operate in this state until a later time.

At some later time power 318 is cut off. When power 318 is cut off, capacitor 302 can no long provide power and the voltage of power 320 begins to drop to a predetermined threshold, e.g., to 0.2 Volts. Non-limiting examples of why power 318 may be cut off include a power outage, unplugged power cord, or hardware malfunction.

Bi-directional buck-boost converter 306 detects that power 320 is below the predetermined threshold. Simultaneously, modem 308 begins operating in dying gasp mode. In dying gasp mode, modem 308 transmits session end signal 328 to the client (not shown), via line 326, in order to end a session until power 318 is returned and modem 308 can resume operation. Once bi-directional buck-boost converter 306 detects drop in the voltage of power 320, it will switch from boost mode to buck mode.

In buck mode, bi-directional buck-boost converter 306 will begin discharging capacitor 304 in order to charge capacitor 302 and power modem 308.

Capacitor 304 will begin delivering power 324 at 20 V, via bi-directional line 316, to buck-boost converter 306. Buck-boost converter 306 steps down the voltage of power 324, e.g., from 20 V to 5 V, and transmits it as power 322 to capacitor 302, via bi-directional line 314. Once capacitor 302 is charged, via buck-boost converter 306 and capacitor 304, it will begin transmitting power 320 to modem 308, via line 312. Modem 308 will then use power 320 to operate in dying gasp mode and transmit session end signal 328 to a client, via line 326, to terminate the session until power 310 is returned.

In other words, in normal operation of two capacitor system 300, bi-directional back-boost converter 306 increases the voltage from Vᵢₙ to V_{cs} for storage on capacitor 304. This increased voltage enables capacitor 304 to store more energy as compared to capacitor 204 as discussed above with reference to FIG. 2. Further, capacitor 304 may be much smaller in size as capacitor 204 and still be able to store much more energy, as a result of the higher voltage. Then, during the dying gasp of two capacitor system 300, bi-directional buck-boost converter 306 is able to provide Vᵢₙ from V_{cs} by discharging capacitor 304.

The operation of an example bi-directional back boost converter system 400 will now be discussed with reference to FIGS. 4A-B.

FIG. 4A illustrates example bi-directional buck boost converter system 400 when operating in a boost mode in accordance with aspects of the present disclosure.

System 400 includes a bi-directional buck-boost converter 402, a diode 404, an inductor 406, a capacitor 408, a modem 410, a ground 412, a compensation component 414, a capacitor 416, and a controlling component 418. In this example embodiment, controlling component 418 is a digital logic controller 418. Bi-directional buck-boost converter 402 additionally includes a switch 420, a switch 422, a high side current sensing component 424, a low side current sensing component 426 a gate driving component 428, a comparator 430, an error amplifier 432, a comparator 434, a reference component 436, a resistor divider 438, and a resistor divider 440.

Bi-directional buck-boost converter 402 is operable to operate in boost mode in a first state, in buck mode in a second state, and in neither boost mode or buck mode in a third state. In the boost mode, capacitor 416 is charging. In the buck mode, capacitor 416 is discharging. In the third state, converter 402 is off.

Diode 404 is operable to allow power 442, via line 446, to flow to inductor 406 and capacitor 408, via bi-directional line 448. Diode 404 is additionally operable to stop power 443 to flow from inductor 406 or capacitor 408 back through diode 404, via bi-directional line 448. In this non-limiting example embodiment, diode 404 is used to control the flow of power 442 and power 443, in other embodiments a reverse blocking switch or active circuitry ma be implemented to control the flow of power 442 and power 443.

Inductor 406 is operable to receive power 442 from diode 404, via bi-directional line 448. Inductor 406 is additionally operable to receive power 442 in a first voltage, and transmit it as power 444 to switch 420 or switch 422, via bi-directional line 452, at a second voltage, where the second voltage is higher than the first voltage. Inductor 406 is further operable to receive power 444 from capacitor 416, via bi-directional line 452, and transmit it as power 443 to capacitor 408, via bi-directional line 448.

Capacitor 408 is operable to receive power 442 from diode 404, via bi-directional line 448, and power 443 from inductor 406, via bi-directional line 448. Capacitor 408 is additionally operable to store and transmit power 442 or power 443 to modem 410, via line 450.

Modem 410 is operable to receive power 442 or power 443 from capacitor 408, via line 450. Modem 410 is additionally operable to operate in a normal operation mode and a dying gasp mode.

Ground 412 provides an electrical ground to CSL 426, via line 462.

Compensation component 414 is operable to provide a compensation signal to comparator 430, via line 472.

Capacitor 416 is operable to receive and store power 444, received via bi-directional line 470. Capacitor 416 is additionally operable to discharge power 444, via bi-directional line 470.

Digital logic controller 418 is operable to instruct bi-directional buck-boost converter 402 to operate in first state (a buck state), a second state (a boost state), or a third state (off), via line 486 based on a comparison from comparator 434 via hue 484.

Switch 420 is operable to be open in a first state, and closed in a second state. Switch 420 is additionally operable to switch from being open to being closed and to switch from being closed to being open, based on a signal received from gate driving component 428, via line 454. Switch 422 is operable to be closed in a first state, and open in a second state. Switch 422 is additionally operable to switch from being open to being closed and to switch from being closed to being open, based on a signal received from gate driving component 428, via line 456. Switch 420 and switch 422 are both further operable to open in a third state.

High side current sensing component 424 is operable to detect a parameter of power 444 between switch 420 and capacitor 416. Non-limiting examples of parameters for which high side current sensing component 424 may detect include, current amplitude, current phase, a change in current and combinations thereof. In an example embodiment discussed hereinafter, high side current sensing component 424 detects an amplitude of current of power 444. High side current sensing component 424 is further operable to generate and transmit a high side signal based on the detected parameter of power 444 to comparator 430, via line 468.

Low side current sensing component 426 is operable to detect a parameter of power 444 between switch 422, and ground 412. Non-limiting examples of parameters for which low side current sensing component 426 may detect include, current amplitude, current phase, a change in current and combinations thereof. In an example embodiment discussed hereinafter, low side current sensing component 426 detects an amplitude of current of power 444. Low side current sensing component 426 is further operable to generate and transmit a low side signal based on the detected parameter of power 444 to comparator 430, via line 464.

Gate driving component 428 is operable to control switch 420 and switch 422 based on a signal received from comparator 430, via line 488. Gate driving component 428 is additionally operable to operate in a first state to control switch 420 and switch 422 such that capacitor 416 may be charged or operate in a second state to control switch 420 and switch 422 such that capacitor 416 may discharge to capacitor 408. Gate driving component 428 is further operable to operate in a third state such that capacitor 416 may not be charged and capacitor 416 cannot discharge to capacitor 408.

Comparator 430 is operable to generate and transmit a signal to gate driving component 428, via line 488, based on the comparison of a high side signal from high side current sensing component 424 and a compensation signal from compensation component 414. Comparator 430 is additionally operable to generate and transmit a signal to gate driving component 428, via line 488, based on the comparison of a low side signal from low side current sensing component 426 and a compensation signal from compensation component 414.

Error amplifier 432 is operable to generate and transmit an error signal to comparator 430, via line 472, based on the comparison of a reference signal from reference component 436 and voltage divider 440. Error amplifier 432 is additionally operable to generate and transmit an error signal to comparator 430, via line 472, based on the comparison of a reference signal from reference component 436 and voltage divider 438.

Comparator 434 is operable to generate and transmit a comparison signal to digital Ionic controller 418, via line 484, based on the comparison of the voltage of power 442 and the voltage of a reference signal from reference component 436.

Reference component 436 is operable to generate and transmit a reference signal to comparator 434, via line 428, and error amplifier 432, via line 480.

Voltage divider 438 is operable to scale down the voltage of power 442 or power 443, received via bi-directional line 448. Voltage divider 438 is additionally operable to transmit power 442 or power 443 with a scaled down voltage to error amplifier 432, via line 476.

Voltage divider 440 is operable to scale down the voltage of power 444 discharged by capacitor 416, via line 482. Voltage divider 440 is additionally operable to transmit power 444 with a scaled down voltage to error amplifier 432, via line 478.

In this example, digital logic controller 418, high side current sensing component 424, low side current sensing component 426, gate driving component 428, comparator 430, error amplifier 432, and comparator 434 are illustrated as individual devices. However, in some embodiments, at least two of digital logic controller 418, high side current sensing component 424, low side current sensing component 426, gate driving component 428, comparator 430, error amplifier 432, and comparator 434 may be combined as a unitary device. Further, in some embodiments, at least one of digital logic controller 418, high side current sensing component 424, low side current sensing component 426, gate driving component 428, comparator 430, error amplifier 432, and comparator 434 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

In operation, at the start-up of example system 400, bi-directional buck-boost converter 402 is in boost mode. When bi-directional buck-boost converter 402 is in boost mode, high side current sensing component 424 is turned off, low side current sensing component 426 is turned on and is connected to comparator 430, via line 464, gate driving component 428 is enabled, error amplifier 432 is connected to voltage divider 440, via line 478, voltage divider 438 is turned off, voltage divider 440 is turned on, and modem 410 is operating in its normal operating mode.

Power 442 is delivered to diode 404 and comparator 434, via line 446. In this example embodiment, power 442 is delivered at a voltage of 10 Volts. As comparator 434 receives power 443, reference component 436 simultaneously transmits a reference signal to comparator 434, via line 428. Comparator 434 then generates a comparison signal based on the comparison of the voltage of power 442 and the voltage of the reference signal. Comparator 434 then transmits the comparison signal to digital logic controller 418.

After receiving the comparison signal from comparator 434, digital logic controller 418 will analyze the signal. If the voltage of power 442 is within 90% of the voltage level of the reference signal, digital logic controller 418 will instruct bi-directional buck-boost converter 402 to continue operating in boost mode. If the voltage of power 442 is not within 90% of the voltage level of the reference signal, digital logic controller 418 will instruct bi-directional buck-boost converter 402 to switch to buck mode.

In this example embodiment, the voltage of power 442 is within 90% of the voltage of the reference signal, and as such bi-directional buck-boost converter 402 continues operating in boost mode. While bi-directional bock-boost converter 402 is in boost mode, comparator 434 will continue comparing the voltage level of power 42 and the voltage level of the reference signal and transmitting the comparison signal to digital logic controller 418.

Diode 404 allows power 442 to flow to either capacitor 408 or inductor 406 based on the state of switch 420 and switch 422. When switch 420 is open and switch 422 is closed, power 442 flows to capacitor 408, via bi-directional line 448. When switch 420 is closed and switch 422 is open, power 442 flows to inductor 406, via bi-directional line 448. When bi-directional buck-boost converter 402 starts in boost mode, switch 420 is open and switch 422 is closed.

At the beginning of the operation of example system 400, there is no power being delivered, so the current in inductor 406 is 0. Once power 442 is delivered and switch 422 is closed, inductor 406 is connected to ground 412. Power 442 wants to flow through inductor 406 to ground 412, but since the current inside inductor 406 is 0, it resists the change in current. As inductor 406 resists the change in current, the current of power 442 is decreased and the voltage of power 442 is increased. In this example embodiment, while switch 422 is closed the current of power 442 is decreases such that the voltage of power 442 is increases from 10 Volts to 20 Volts.

Additionally, since inductor 406 is resisting the change in current, low side current sensing component 426 does not detect any current between switch 422 and ground 412. Low side current sensing component 426 then generates and transmits a low side signal based on the detected current, and transmits it to comparator 430, via line 464.

Since switch 422 is closed and switch 420 is open, no power is being discharged to capacitor 416, so the voltage of the power being discharged to capacitor 416 is 0. The voltage of power being discharged to capacitor 416 is transmitted to voltage divider 440, via line 482. Voltage divider 440 steps down the voltage level received so it is at a usable level, since the voltage is already 0, it remains unchanged by voltage divider 440. Voltage divider 440 then transmits the voltage level of power being delivered to capacitor 416 to error amplifier 432, via line 478.

As error amplifier 432 receives the voltage level of power discharged to capacitor 416, it also receives a reference signal from reference component 436, via line 480. Error amplifier 432 then generates an error signal based on the voltage of capacitor 416 from voltage divider 440 and the reference signal from reference component 436. Error amplifier 432 then transmits the error signal to comparator 430, via line 472.

At this point, comparator 430 compares the low side signal from low side current sensing component 426 and the error signal from error amplifier 432. Comparator 430 then generates and transmits a comparison signal to gate driving component 428, via line 488, based on the comparison of the low side signal from low side current sensing component 426 and the error signal from error amplifier 432.

Comparator 430 finds that the voltage level of power discharged to capacitor 416 is too low, due to inductor 406 resisting the change in current. Since the voltage level of power discharged to capacitor 416 is too low, gate driving component instructs switch 420 to close and switch 422 to open.

At this point, the current in inductor 406 increases as power 442 is forced to flow through inductor 406 at a lower current and higher voltage as power 444. Since switch 422 is closed, and switch 424 is open, power 444 flows to capacitor 416, via bi-directional line 452, bi-directional line 458, and bi-directional line 470. Once delivered capacitor 416 begins to charge as it stores power 444. Simultaneously, power 442 is discharged from diode 404 to capacitor 408, via line 443. Capacitor 408 begins charging as it stores power 442.

As described above, low side current sensing component 426 generates a low side signal based on the current between switch 422 and ground 412. Once generated it is transmitted to comparator 430. Simultaneously, voltage divider 440 lowers the voltage level of power 411 to a usable level and transmits the voltage level to error amplifier 432. Error amplifier 432 then generates and transmits an error signal to comparator 430.

After receiving both the error signal from error amplifier 432 and low side signal from low side current sensing component 426, comparator 430 compares the two signals. After the comparison, comparator 430 generates a comparison signal and transmits it to gate driving component 428.

Gate driving component 428 will continue to keep switch 420 closed and switch 422 open until comparator 430 finds that the voltage level of power 444 being discharged to capacitor 416 is too low. Once comparator 430 finds that the voltage of power 444 is too low it will open switch 420 and close switch 422.

Once switch 420 is open and switch 422 is closed, power 442 will be discharged from capacitor 404 to inductor 406. While discharging to capacitor 416, the current in inductor 406 returned to 0, so when inductor 406 receives power 442 it begins charging as it resists the change in current as described above.

Simultaneously, since power 442 is no longer being discharged capacitor 408, it stops charging and begins discharging stored power to modem 410, via line 450. Gate driving component 428 will continue opening and closing switch 420 and switch 422 in order to charge capacitor 416 and power modem 410.

In this example embodiment, gate driving component 428 is opening and closing switch 420 and switch 422 quickly and continually, using a PWM signal. The duty cycle of the PWM signal can be modified to control the rate at which inductor 406 charges and discharges. Since the voltage of power 444 depends on the amount of time inductor 406 charges, the voltage of power 444 discharged to capacitor 416 can be precisely controlled.

For purposes of discussion, suppose that at some time later, digital logic controller 418 analyzes the comparison signal from comparator 434 and finds that the voltage level of power 442 is less than 90% of the voltage level of the reference signal from reference component 436. At this point, digital logic controller 418 instructs bi-directional buck-boost converter 402 to disable gate driving component 428 and to switch from boost mode to buck mode.

Bi-directional buck-boost converter 402 of example system 400 operating in buck mode will now be described with additional reference to FIG. 4B.

In operation, when bi-directional buck-boost converter 402 switches from boost mode to buck mode, high side current sensing component 424 is turned on, low side current sensing component 426 is turned off, high side current sensing component 426 is connected to comparator 430, via line 468 gate driving component 428 is disabled, error amplifier 432 is connected to voltage divider 438, via line 476, voltage divider 438 is turned on voltage divider 440 is turned off, and modem 410 is operating m dying gasp mode.

When bi-directional buck-boost converter 402 switches from boost mode to buck mode, gate driving component 428 is disabled. When gate driving component 428 is disabled, it opens switch 420 and switch 422 to allow the current in inductor 406 to return to 0. After a predetermined amount of time, digital logic controller 418 instructs bi-directional buck-boost converter 402 to enable gate driving component 428. In this example embodiment, the predetermined amount of time before enabling gate driving component 428 is 10 microseconds.

Once enabled, gate driving component 428 closes switch 420 and opens switch 422. After switch 420 is closed, stored energy is discharged from capacitor 416 is discharged as power 444 to inductor 406, via bi-directional line 470, bi-directional line 458, and bi-directional line 452. Once again, since the current in inductor 406 is 0, it charges as it resists the change in current due to power 444.

High side current sensing component 424 monitors the current of power 444 being discharged from capacitor 416 to inductor 406. High side current sensing component 424 then generates and transmits a high side signal to comparator 430, via line 468.

Simultaneously, the voltage level of power discharged from inductor 406 is transmitted to voltage divider 438, via bi-directional line 448. The operation of voltage divider 438 is similar to that of voltage divider 440 as described above in FIG. 4A. Voltage divider 438 steps down the voltage level received so it is at a usable level, since the voltage is already 0, it remains unchanged by voltage divider 438. Voltage divider 438 then transmits the voltage level of power being discharged by inductor 406 to error amplifier 432, via line 476.

As error amplifier 432 receives the voltage level of power being discharged by inductor 406, it simultaneously receives a reference signal from reference component 436. Error amplifier 432 then generates an error signal from the voltage level of power being discharged by inductor 406 and the voltage level of the reference signal from reference component 436. After generating the error signal, error amplifier 432 transmits the error signal to comparator 430, via line 472.

Comparator 430 then compares the high side signal from high side current sensing component 424 and the error signal from error amplifier 432. Comparator 430 then generates a comparison signal based on the comparison, and then transmits the comparison signal to gate driving component 428, via line 488.

Comparator 430 finds that the voltage level of power being discharged by inductor 406 being discharged by inductor 406 is too low. After receiving the comparison signal, gate driving component 428 opens switch 420 and closes switch 422.

After switch 420 is open and switch 422 is closed, capacitor 416 stops discharging power 444 and inductor 406 begins discharging power 444 as power 443. As inductor 406 discharges, the current of power 443 begins to increase and the voltage of power 443 decreases. As the current increases, the voltage of power 443 stepped down from 20V to 10V. Diode 404 prevents power 443 from being discharged back to the power supply via line 446. Since power 443 cannot be discharged back past diode 404 it is discharged to capacitor 408, via bi-directional line 448. As capacitor 408 receives power 443 it begins to charge.

The voltage of power 443 discharged to capacitor 408 is transmitted to voltage divider 438, via bi-directional line 448. As described above, voltage divider 438 steps down the voltage of power 433 to a usable level and transmits it to error amplifier 432. Error amplifier 432 then generates an error signal based on the voltage of power 443 and reference signal of reference component 436. Error amplifier 432 then transmits the error signal to comparator 430. Comparator 430 generates a comparison signal based on the comparison of the error signal to the high side signal from high side current sensing component 424. Comparator 430 then transmits the comparison signal to gate driving component 424.

In this example embodiment comparator 430 finds that the voltage of power 443 is too low. After receiving the comparison signal, gate driving component 428 closes switch 420 and opens switch 422.

Once switch 420 is closed, inductor 406 stops discharging power 443 and begins charging as capacitor 416 begins discharging power 444 to inductor 406. Simultaneously, since inductor 406 is no longer discharging power 443, capacitor 408 begins discharging stored power to modem 410, via line 450. Gate driving component 428 will continue opening and closing switch 420 and switch 422 in order to discharge capacitor 416 and power modem 410.

Similar to FIG. 4A, gate driving component 428 is opening and closing switch 420 and switch 422 quickly and continually, using a PWM signal. The duty cycle of the PWM signal can be modified to control the rate at which capacitor 416 discharges to inductor 406 as well as the rate at which inductor 406 discharges. Since the voltage of power 443 depends on the amount of time inductor 406 discharges, the voltage of power 443 discharged to capacitor 408 can be precisely controlled.

Gate driving component will continue opening and closing each of switch 420 and switch 422 in order to precisely control the discharge of power 444 from capacitor 416 to capacitor 408 as well as the rate at which capacitor 408 discharges power 443 to modem 410 is correct.

Bi-directional buck-boost digital logic controller 402 will continue to operate in this manner to deliver power stored by capacitor 416 to modem 410, while modem 410 is operating in its dying gasp mode.

At a later time, digital logic controller 418 will be informed about power 442 returning by comparator 434, via line 448. Once power 442 returns, digital logic controller 418 will instruct bi-directional buck-boost convener 402 to disable gate driving component 428 and to switch from buck mode to boost mode. Once in boost mode, example system 400 will operate as described above in FIG. 4A.

A problem with the conventional system and method for delivering power to a device while it operates in its dying gasp mode is that it uses a single capacitor. Using a single capacitor to deliver power to a device during its dying gasp mode requires a capacitor to store energy at a low voltage since it is connected directly in the path between a power supply and a device.

The present disclosure presents a system and method for using two capacitors to deliver power to a device during its dying gasp mode. During normal operation, the first capacitor can be used to store and deliver power to a device when power is being provided by a power supply. Excess power can be sent to the storage capacitor to store energy to be used during a devices dying gasp mode. The voltage of the power from a power supply can be boosted before being sent to the storage capacitor using a bi-directional buck-boost converter. Increasing the voltage at which the storage capacitor stores energy decreases the overall system cost and site because the amount of energy stored by a capacitor is proportional to the voltage of the power it stores.

When power is cut and a device enters its dying gasp mode, the bi-directional buck-boost converter can be used to transmit power from the storage capacitor to the device. Storing energy at a higher voltage on a second capacitor allows power to be provided during a devices dying gasp mode using a smaller capacitor decreasing size and system cost.

Another problem with the conventional system and method for delivering power to a device while it operates in its dying gasp mode is that they are not very efficient. The conventional system and method for storing and delivering power to a device in its dying gasp mode requires large and inefficient converters to convert and store energy. Using large and inefficient converters requires larger components, increasing the size of the device.

The present disclosure provides a system and method for using two capacitors and a bi-directional buck-boost converter that does not use complex circuitry. The present disclosure reduces the complexity and size of a circuit while still being able to charge a storage capacitor during a devices normal operation mode, and use the same circuit to discharge the storage capacitor during a devices dying gasp mode. Using less complex circuitry for a bi-directional buck-boost converter further reduces the overall cost of a system.

The foregoing description of various preferred embodiments of the disclosure have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed as new and desired to be protected by Letters Patent of the United States is:

1. A device comprising:
an input voltage supply line operable to receive an input voltage, Vᵢₙ;
a processing component arranged to receive Vᵢₙ and operable to perform a function using Vᵢₙ;
an input capacitor operable to store an input capacitance voltage, V_{cin}, from Vᵢₙ;
a storage capacitor operable to store a storage capacitance voltage, V_{cs};
a buck/boost converter operable to provide V_{cs} to the storage capacitor in a first state such that V_{cs}>V_{cin}, and operable to provide energy to the input capacitor from the storage capacitor in a second state; and
a controlling component operable to control the buck/boost converter to operate in the second state when Vᵢₙ is below a predetermined threshold.

2. The device of claim 1, in which the buck/boost converter comprises a current-mode controlled bidirectional buck/boost converter and further comprises:
an inductor having a first terminal and a second terminal, the first terminal being connected to the input capacitor;
a high side switch disposed between the storage capacitor and the inductor;
a low side switch disposed between the inductor and ground;
a high side current detecting component disposed between the storage capacitor and the high side switch, the high side current detecting component being operable to generate a high side current detection signal based on a high side current between the storage capacitor and the high side switch;
a low side current detecting component disposed between the low side switch and ground, the low side current detecting component being operable to generate a low side current detection signal based on a low side current between the low side switch and ground; and
a gate driving component operable to control the high side switch and the low side switch based on the high side current detection signal and the low side current detection signal.

3. The device claim 2, in which the controlling component operable to control the gate driving component to operate in a first state so as to control the low side switch and the high side switch so as to charge the storage capacitor is the inductor.

4. The device claim 3, in which the controlling component is further operable to control the gate driving component to operate in a second state so as to control the high side switch and the low side switch so as to discharge the storage capacitor to the input capacitor via the inductor.

5. The device claim 4,
in which the controlling component is further operable to control the gate driving component to operate in a third state so as to control the high side switch and the low side switch so as not to charge the storage capacitor and so as not to discharge the storage capacitor to the input capacitor via the inductor,
in which the controlling component is operable to control the gate driving component to operate in the third state between the first state and the second state.

6. The device claim 2, in which the controlling component is operable to control the gate driving component to operate in a first state so as to control the high side switch and the low side switch so as to discharge the storage capacitor to the input capacitor via the inductor.

7. The device of claim 1, in which the buck/boost converter comprises:
an inductor having a first terminal and a second terminal, the first terminal being connected to the input capacitor;
a high side switch disposed between the storage capacitor and the inductor;
a low side switch disposed between the inductor and ground;
a high side detecting component disposed between the storage capacitor and the high side switch, the high side detecting, component being, operable to generate a high side detection signal based on a high side parameter between the storage capacitor and the high side switch;
a low side detecting component disposed between the low side switch and ground, the low side detecting component being operable to generate a low side detection signal based on a low side parameter between the low side switch and ground; and
a gate driving component operable to control the high side switch and the low side switch based on the high side detection signal and the low side detection signal.

8. The device claim 7, in which the controlling component is further operable to control the gate driving component to operate in a first state so as to control the high side switch and the low side switch so as to charge the storage capacitor.

9. The device claim 8, in which the controlling component is further operable to control the gate driving component to operate in a second state so as to control the high side switch and the low side switch so as to discharge the storage capacitor to the input capacitor.

10. The device claim 9,
in which the controlling component is further operable to control the gate driving component to operate in a third state so as to control the high side switch and the low side switch so as not to charge the storage capacitor and so as not to discharge the storage capacitor to the input capacitor,
in which the controlling component is operable to control the gate driving component to operate in the third state between the first state and the second state.

11. A method comprising:
receiving, via an input voltage supply line, an input voltage, Vᵢₙ;
performing, via a processing component arranged to receive Vᵢₙ, a function using Vᵢₙ;
storing, via an input capacitor, an input capacitance voltage, V_{cin}, from Vᵢₙ;
storing, via a storage capacitor, a storage capacitance voltage, V_{cs};
providing, via a buck/boost converter, V_{cs} to the storage capacitor in a first state such that V_{cs}>V_{cin};
providing, via the buck/boost converter, energy to the input capacitor from the storage capacitor in a second state; and
controlling, via a controlling component, the buck/boost converter to operate in the second state when Vᵢₙ is below a predetermined threshold.

12. The method of claim 11, in which the buck/boost converter comprises a current-mode controlled bidirectional buck/boost converter and further comprises:
an inductor having a first terminal and a second terminal, the first terminal being connected to the input capacitor;
a high side switch disposed between the storage capacitor and the inductor;
a low side switch disposed between the inductor and ground;
a high side current detecting component disposed between the storage capacitor and the high side switch, the high side current detecting component being operable to generate a high side current detection signal based on a high side current between the storage capacitor and the high side switch;
a low side current detecting component disposed between the low side switch and ground, the low side current detecting component being operable to generate a low side current detection signal based on a low side current between the low side switch and ground; and
a gate driving component operable to control the high side switch and the low side switch based on the high side current detection signal and the low side current detection signal.

13. The method claim 12, including controlling, via the controlling component, the gate driving component to operate in a first state so as to control the low side switch and the high side switch so as to charge the storage capacitor via the inductor.

14. The method claim 13, including controlling, via the controlling component, the gate driving component to operate in a second state so as to control the high side switch and the low side switch so as to discharge the storage capacitor to the input capacitor via the inductor.

15. The method claim 14, including:
controlling, via the controlling component, the gate driving component to operate in a third state so as to control the high side switch and the low side switch so as not to charge the storage capacitor and so as not to discharge the storage capacitor to the input capacitor via the inductor,
in which the controlling component is operable to control the gate driving component to operate in the third state between the first state and the second state.

16. The method claim 12, including controlling, via the controlling component, the gate driving component to operate in a first state so as to control the high side switch and the low side switch so as to discharge the storage capacitor to the input capacitor via the inductor.

17. The method of claim 11, in which the buck/boost converter comprises:
an inductor having a first terminal and a second terminal, the first terminal being connected to the input capacitor;
a high side switch disposed between the storage capacitor and the inductor;
a low side switch disposed between the inductor and ground;
a high side detecting component disposed between the storage capacitor and the high side switch, the high side detecting component being operable to generate a high side detection signal based on a high side parameter between the storage capacitor and the high side switch;
a low side detecting component disposed between the low side switch and ground, the low side detecting component being operable to generate a low side detection signal based on a low side parameter between the low side switch and ground; and
a gate driving component operable to control the high side switch and the low side switch based on the high side detection signal and the low side detection signal.

18. The method claim 17, including controlling, via the controlling component, the gate driving component to operate in a first state so as to control the high side switch and the low side switch so as to charge the storage capacitor.

19. The method claim 18, including controlling, via the controlling component, the gate driving component to operate in a second state so as to control the high side switch and the low side switch so as to discharge the storage capacitor to the input capacitor.

20. The method claim 19,
controlling, via the controlling component, the gate driving component to operate in a third state so as to control the high side switch and the low side switch so as not to charge the storage capacitor and so as not to discharge the storage capacitor to the input capacitor,
in which the controlling component is operable to control the gate driving component to operate in the third state between the first state and the second state.
